(19) United States
(12) Patent Application Publication
(10) Pub. No.: US 2015/0103699 A1
(43) Pub. Date: Apr. 16, 2015

(54) Interface Optimization

(71) Applicant: Cisco Technology, Inc., San Jose, CA (US)

(72) Inventors: Nirav Kirtikumar Salot, Pune (IN); Sebastian Speicher, Wallisellen (CH); Ravi Kiran Guntupalli, Johns Creek, GA (US); Maulik Vijay Vaidya, Atlanta, GA (US)

(73) Assignee: Cisco Technology, Inc., San Jose, CA (US)

(21) Appl. No.: 14/052,714

(22) Filed: Oct. 12, 2013

(51) Int. Cl. H04L 12/14

(52) U.S. Cl. CPC H04L 12/1407
USPC 370/259

(57) ABSTRACT

Policy enforcement may be provided. First, a Policy and Charging Enforcement Function (PCEF) server may receive a plurality of network policies along with validity information. The PCEF server may receive a first set of connectivity data associated with a subscriber session. Next, the PCEF server may analyze the first set of connectivity data to determine a first set of policies. The PCEF may then enforce those policies. The PCEF may further receive a second set of connectivity data associated with the subscriber session. The second set of connectivity data may indicate, for example, a change in radio access technology of the subscriber session or a change in location of a subscriber device. Next, the PCEF may analyze the second set of connectivity data to determine a second set of policies to enforce without interacting with a Policy and Charging Rules Function server. The PCEF may then enforce those policies.

### BACKGROUND

Frequent trigger activations between a Policy and Charging Enforcement Function (PCEF) server and a Policy and Charging Rules Function (PCRF) server may cause excessive Gx signaling. In turn, excessive Gx signaling may result in an extraneous consumption of resources in a network. Such extraneous consumption of resources may impede the performance of the PCEF and PCRF. Impeded performance of the PCEF and PCRF may result in a lower quality of service provided to millions of subscribers relying on efficient communication.

### BRIEF DESCRIPTION OF THE DRAWINGS

The accompanying drawings, which are incorporated in and constitute a part of this disclosure, illustrate various embodiments of the present disclosure. In the drawings:

FIG. 1 is a block diagram of an operating environment;

FIG. 2 is a flow chart of a method for providing policy enforcement; and

FIG. 3 is a block diagram of a system including a policy enforcement server.

### DETAILED DESCRIPTION

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made and the methods described herein may be modified by substituting, reordering, or adding stages to the disclosed methods. Accordingly, the following detailed description does not limit the disclosure. Instead, the proper scope of the disclosure is defined by the appended claims.

### Overview

Policy enforcement may be provided. First, a Policy and Charging Enforcement Function (PCEF) server may receive a plurality of network policies, each network policy comprising validity information. The PCEF server may then receive a first set of connectivity data associated with a subscriber session. Next, the PCEF server may analyze the first set of connectivity data to determine a first set of policies to enforce. Having determined the first set of policies, the PCEF may then enforce those policies. The PCEF may further receive a second set of connectivity data associated with the subscriber session. The second set of connectivity data may indicate, for example, a change in radio access technology (RAT) of the subscriber session or a change in location of a subscriber device. Next, the PCEF may analyze the second set of connectivity data to determine a second set of policies to enforce without interfacing with a Policy and Charging Rules Function (PCRF) server. Having determined the second set of policies, the PCEF may then enforce those policies.

### Example Embodiments

Consistent with embodiments of the present disclosure, a service provider may control various parameters of its service provision to subscribers. For example, the service provision may be based on factors associated the subscribers and their devices. In some embodiments, the service provider may analyze a radio access technology (RAT) used by a subscriber to access the subscriber's network. The service provider may then determine which service provision policies to enforce based on, for example, the RAT used by the subscriber.

Subscribers receiving service through a first RAT (e.g., 2G/3G) may be serviced under a first set of policies while subscribers receiving service through a second RAT (e.g., LTE) may be serviced under a second set of policies. Accordingly, in some embodiments, service polices may be a function of the RAT. Service policies, consistent with embodiments of the present disclosure, may serve to regulate various aspects of the service provision including, but not limited to, for example, bandwidth limits and charging rules. One scheme from regulating service provision may be through a Policy Control and Charging (PCC) and/or Application Detection and Control (ADC) environment.

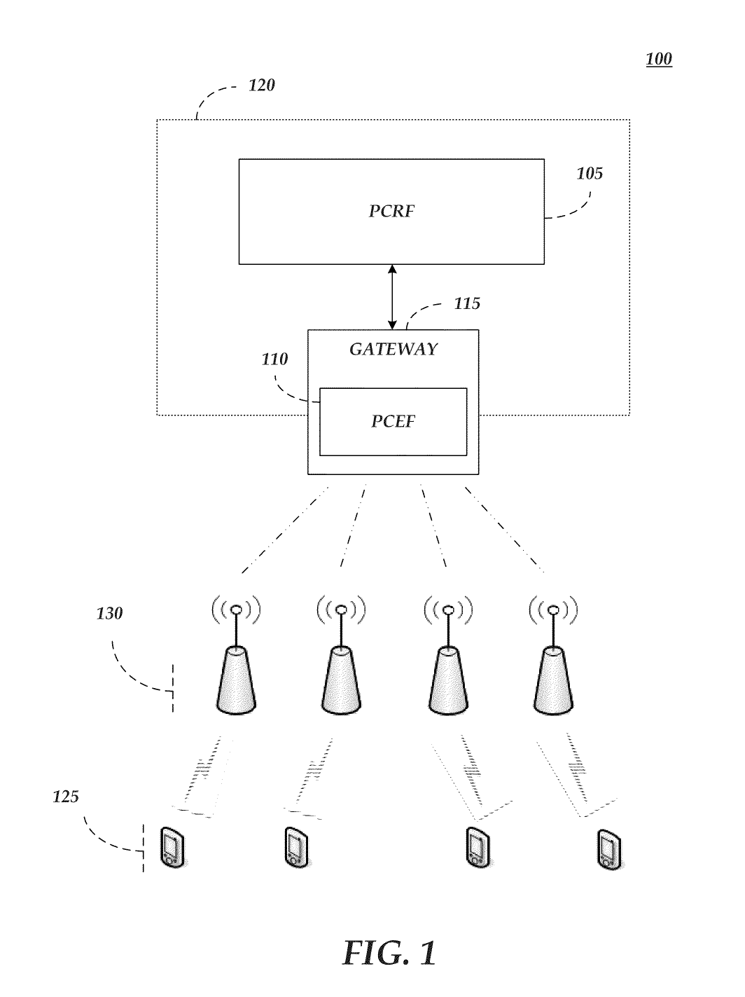

FIG. 1 is a block diagram of a PCC environment 100. An operator of PCC 100 may define a plurality of policies and a plurality of triggers for activating the policies. These polices may include, for example, PCC rules and ADC rules. The policy definitions may be stored in, for example, a Policy and Charging Rules Function (PCRF) server 105. PCRF 105 may activate a reception of connectivity data for the subscriber session (e.g., the RAT type, location information, and the like) from PCEF 110. Consequently, PCRF 105 may receive information on, for example, a subscriber's activity and determine which policies to enforce based on the subscriber's activity. PCRF 105 may pass the necessary policies to a Policy and Charging Enforcement Function (PCEF) server 110. In turn, PCEF 110 may enforce the policies it receives from PCRF 105.

Consistent with embodiments of the present disclosure, PCEF 110 may reside in, for example, a gateway 115. Gateway 115 may serve as the connection point between a subscriber device 125 and a service provider's network 120. Consequently, network traffic between service provider's network 120 and subscriber device 125 may pass through gateway 115. Residing at this connection point, PCEF 110 may be enabled to both monitor and control various parameters of the network traffic between the service provider and the subscriber.

Consistent with embodiments of the disclosure, service provider's network 120 may comprise any type of network (e.g., the Internet, a hybrid fiber-coaxial (HFC) network, a content delivery network (CDN), etc.) capable of communicating data. Subscriber device 125 may comprise, but is not limited to, a personal computer, a tablet device, a mobile device, a smart phone, a telephone, a remote control device, a network computer, or other similar microcomputer-based device. Subscriber device 125 may comprise any type device capable of transmitting, receiving, and processing data.

As mentioned above, PCC 100 may comprise plurality of policies and a plurality of triggers for activating the policies. While the policy definitions may be stored in PCRF 105, the triggers for activating the policies may be communicated to PCEF 110 by PCRF 105 and hence may be stored in PCEF 110. A trigger stored on PCEF 110 may correspond to a predefined event. The predefined event may be, for example, the subscriber's switch from, for example, the first RAT (e.g., 2G/3G) to the second RAT (e.g., LTE).

Consistent with embodiments of the present disclosure, PCEF 110 may monitor the subscriber's network parameters for the occurrence of predefined events. The occurrence of predefined events may activate corresponding triggers stored in PCEF 110. A trigger may be activated when PCEF 110 detects the predefined event. In turn, the trigger may cause PCEF 110 to inform PCRF 105 of the occurrence of the predefined event.

Having notice of the event, PCRF 105 makes a determination whether PCEF 110 should be updated with a new set of policies for controlling the service provision. For example, the policies being enforced by PCEF 110 at the time of the detected event's occurrence may not be applicable to service provision through a different RAT. Accordingly, should PCRF 105 determine that a new set of policies are necessary, it may, in turn, perform a look-up through its database of stored polices and communicate the new set of policies to the PCEF 110. PCEF 110 may then enforce the new set of policies that are now applicable to the subscriber's different RAT.

One drawback to event and policy communication between PCRF 105 and PCEF 110 is that it may require a significant amount of signaling interactions. Excessive signaling, in turn, consumes resources in the PCRF 105 and PCEF 110. For instance, signaling interaction between the PCEF 110 and PCRF 105 may be required when PCEF 110 is triggered by the detected occurrence of a predefined event. Signaling may further be required each time PCRF 105 communicates a set of policies to PCEF 110 in response to the triggers. Thus, a significant amount of signaling, for every subscriber, may be required when, for example, a subscriber switches to a new RAT.

Moreover, the amount of signaling may substantially increase in certain scenarios. For example, operating within areas of bad radio coverage or along a border of two radio coverage areas may cause subscriber device 125 to frequently change from one RAT to another in search of the strongest signal coverage. In such scenarios, each transition from one RAT to the other may cause the activation of a trigger in the PCEF 110. As discussed above, trigger activation may begin a sequence of communications between PCEF 110 and PCRF 105, which may be embodied in, for example, Gx signaling.

Embodiments of the present disclosure may reduce the amount of Gx signaling interaction by preinstalling a plurality of policies along with validity information on PCEF 110. For example, having the policies preinstalled on PCEF 110 enables PCEF 110 to activate, without interacting with PCRF 105, the policies for a given RAT type once it detects that subscriber device 125 has switched to that RAT type. Similarly, PCEF 110 may deactivate polices that are not valid for a currently used RAT type.

Consistent with embodiments of the present disclosure, PCC 100 may be extended to include validity information for each of its policies. Validity information may comprise, for example, a list of RAT types and the policies that may apply to the RAT types. By including validity information with the policies and storing the policies on PCEF 110, PCEF 110 may have both the policies and the data needed to properly enforce the policies without interacting with PCRF 105.

Though the foregoing embodiments have been disclosed in operation with 2G/3G and LTE RAT type triggers, other RAT type triggers may also be regulated in PCC 100. For example, PCC 100 may be operative with high rate packet data (HRPD) and wireless local area network (WLAN) RATs. Furthermore, embodiments of PCC 100 may not be limited to RAT type triggers. For example, PCC 100 may be operative with Internet Protocol Connectivity Access Network (IP-CAN) type triggers or PLMN ID triggers. In these embodiments, PCRF 105 and PCEF 110 may be operative with various IP-CAN type or PLMN ID policies such as, for example, but not limited to IP-CAN type NON-3Gpp-EPS, IP-CAN type 3Gpp-EPS, enhanced (E)HRPD, and CDMA2000.

Still consistent with embodiments of the present disclosure, PCC 100 may be extended to support location-specific policies. For example, subscribers in a certain geographic area may not be allowed to receive specific services (e.g., restrictions on delivering multimedia content because of copyright limitations).

Accordingly, though the present disclosure is described with reference to RAT type policy enforcement, it should be understood that embodiments of the present disclosure are not limited to any specific service provision type or any specific enforcement policies for the service provision. Rather, embodiments of the present disclosure may apply to many different service provision types and enforcement policies.

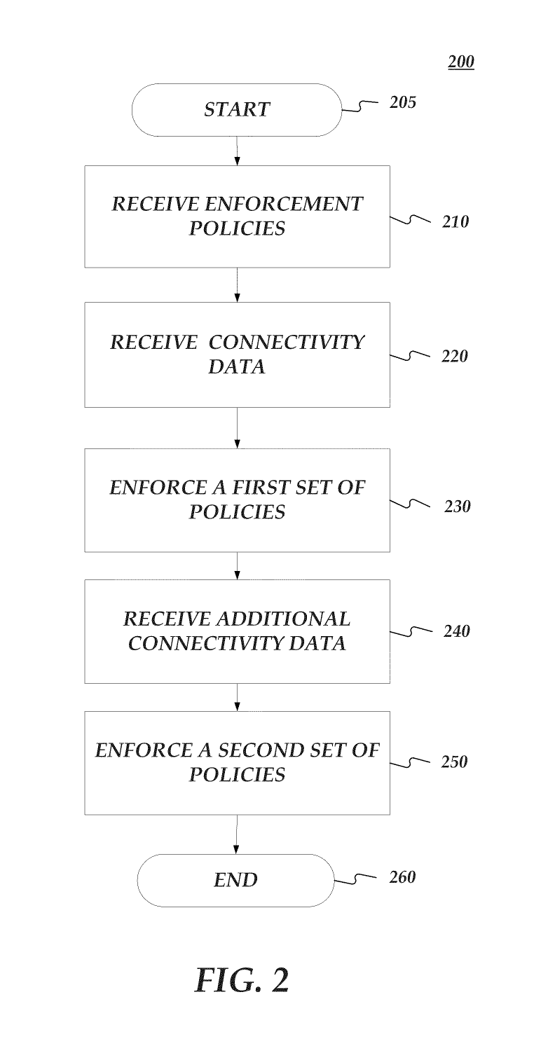

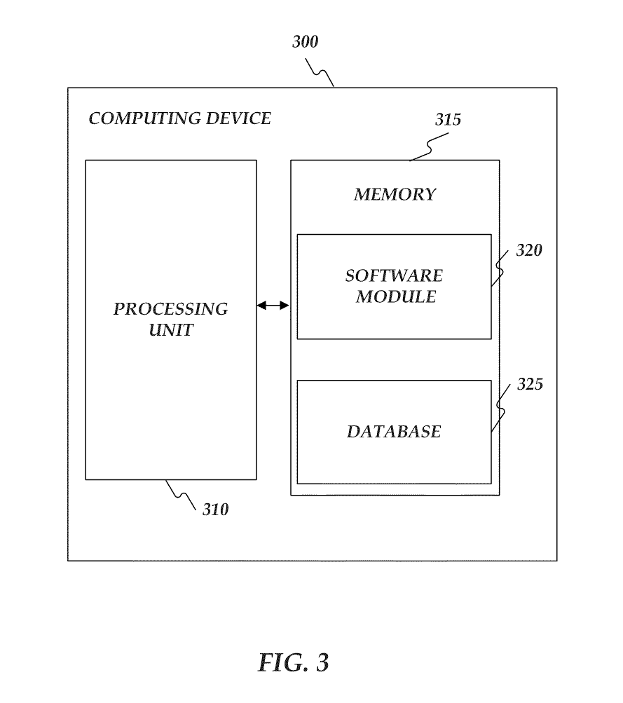

FIG. 2 is a flow chart setting forth the general stages involved in a method 200 consistent with an embodiment of the disclosure for providing policy enforcement. Method 200 may be implemented using PCEF 110 as described in more detail below with respect to FIG. 3. Ways to implement the stages of method 200 will be described in greater detail below.

Method 200 may begin at starting block 205 and proceed to stage 210 where PCEF 110 may be provisioned with a plurality of policies. Consistent with embodiments of the present disclosure, the policies may be received from, for example PCRF 105. PCRF 105 may be programmed with a plurality of policies by an operator of PCC 100. The policies may include, for example, PCC rules and/or ADC rules. In certain embodiments, the operator may program each of the plurality of policies with validity information. The validly information may help PCEF 110 determine when to enforce which policy. Validly information may include, for example, but not be limited to:

RAT types to which a corresponding policy may apply;

IP-CAN types to which a corresponding policy may apply;

PLMN IDs to which a corresponding policy may apply;

Core nodes (CNs) to which a corresponding policy may apply;

Geographical area to which a corresponding policy may apply;

Network load to which a corresponding policy may apply;

Network congestion to which a corresponding policy may apply; and

Time zones to which a corresponding policy may apply.

Having received the policies with the validity information in stage 210, method 200 may advance to stage 220 where PCEF 110 may receive a first set of connectivity data. The connectivity data may be received indirectly from, for example, subscriber device 125 and comprise various data on subscriber device 125's network parameters. For example, the connectivity data may indicate a RAT type or an IP-CAN type connection being used by subscriber device 125. Moreover, the connectivity data may include location information for subscriber device 125 as well as network usage information.

In conventional policy enforcement systems and methods, PCEF 110 would analyze the connectivity data for activating event triggers. In turn, these triggers would signal PCRF 105 to determine whether a new set of policies would need to be provisioned to PCEF 110 in order to enforce the proper policies in view of the connectivity data. However, embodiments of the present disclosure may circumvent the need to re-provision PCEF 110 with new policies from PCRF 105 upon triggers in the connectivity data. Rather, a plurality of policies may be preinstalled on PCEF 110 in an initial provisioning stage and then activated as needed based on the validity information accompanying the policies. In this way, PCEF 110 may analyze the connectivity data against the validly information instead of, for example, constantly relying on PCRF 105 re-provisioning.

After receiving the connectivity data in stage 220, method 200 may proceed to stage 230 where PCEF 110 may enforce a first set of policies upon subscriber device 125. For example, PCEF 110 may use the validity information accompanying each policy as conditions for enforcing the policies. The PCEF 110 may compare the connectivity data against the conditions in the validity information. When a condition is met, PCEF 110 may activate a corresponding policy. Similarly, when the condition is not met, PCEF 110 may deactivate the corresponding policy. In this way, PCEF 110 may activate and/or deactivate its preinstalled policies to provide policy enforcement.

From stage 230 where PCEF 110 may enforce the first set of policies, method 200 may proceed to stage 240 where PCEF 110 may receive a second set of connectivity data associated with subscriber device 125. The connectivity data may indicate, for example, that subscriber device 125 has connected to a new access point 130. For example, subscriber device 125 may access network 120 from various access points 130. Access points 130 may comprise, for example, cell towers, routers, gateways, or any other hardware and/or software that may be operative to connect subscriber device 125 to network 120. In some embodiments, different PCEF servers may be associated with a different access points (e.g., cell towers).

When subscriber device 125 switches its connectivity from an access point associated with PCEF 110 to an access point associated with a different PCEF server, method 200 may proceed back to stage 210 where the different PCEF server may be provisioned with the set of enforcement policies.

In various embodiments, the connectivity data may indicate subscriber device 125's switch from a first RAT (e.g., 2G/3G) to a second RAT (e.g., LTE) on the same PCEF. In response, method 200 may proceed to stage 250 where PCEF 110 may analyze its stored policies and validation information to determine which policies to activate and deactivate to provide the property type of service to subscriber device 125 at the second RAT.

Consistent with embodiments of the present disclosure, the validity information may be further configured to allow for limiting the applicability of certain policies. For example, in certain network congestion or load situation (e.g., when subscriber device 125 is accessing the network during peak traffic hours), it may be more efficient to enforce a policy that would otherwise be inactive during non-peak traffic hours. Accordingly, the validity information for each policy may be variable to factors such as, for example, network congestion and load.

Still consistent embodiments of the present disclosure, certain policies may need to be dynamically determined by PCRF 105. In such scenarios, PCEF 110 may communicate with PCRF 105 to retrieve the dynamic policies in accordance to, for example, TS 23.203 protocol. PCEF 110 may then continue to monitor subscriber device 125's activity to detect whether any of the conditions provided by the validity information are met and enforce corresponding policies. Method 200 may end at stage 260.

Embodiments of the present disclosure may be extended to scenarios where the Event Reporting Function (ERF) is located in the Bearer Binding and Event Reporting Function (BBERF). In these scenarios, a Quality of Service Control rule may be extended with validity information in a similar way that the PCC rules and ADC rules are extended with validity information. The validity information may comprise data points that are operable with the ERF event triggers. In this way, the amount of GX signaling may be reduced when, for example, Proxy Mobile Internet Protocol (PMIP) based interfaces are deployed.

Embodiments of the present disclosure may provide a memory storage and a processing unit for performing a method of policy enforcement. The processing unit may be configured to: receiving, at a PCEF server, a plurality of policies from a PCRF server, wherein each of the plurality of policies comprises at least one rule and at least one condition for activating the at least one rule; receive connectivity data associated with the subscriber device; determining, at the PCEF, whether the connectivity data meets the at least one condition for activating the at least one rule; and activate the at least one rule when the connectivity data meets the at least one condition.

Embodiments of the present disclosure may provide a memory storage and a processing unit for performing a method of policy enforcement. The processing unit may be configured to: receive a plurality of network policies, each network policy comprising validity information; receive a first set of connectivity data associated with a subscriber device; analyze the first set of connectivity data to determine a first set of policies to enforce; enforce the first set of policies; receive a second set of connectivity data associated with the subscriber device, the second set of connectivity data indicating at least one of the following: a change in radio access technology (RAT) of the subscriber device and a change in location of the subscriber device; analyze the second set of connectivity data to determine a second set of policies to enforce; and enforce the second set of policies.

FIG. 3 shows a computing device 300 that may provide an operating environment for PCEF 110 or PCRF 105. As shown in FIG. 3, computing device 300 may include a processing unit 310 and a memory unit 315. Memory unit 315 may include a software module 320 and a database 325. While executing on processing unit 310, software module 320 may perform processes for providing policy enforcement, including for example, any one or more of the stages from method 200 described above with respect to FIG. 2.

Computing device 300 (“the processor”) may be implemented using a gateway 115, Wi-Fi access point 130, a cellular base station, a tablet device, a mobile device, a smart phone, a telephone, a remote control device, a set-top box, a digital video recorder, a cable modem, a personal computer, a network computer, a mainframe, a router, a smart TV-like device, a network storage device, a network relay devices, or other similar microcomputer-based device. The processor may comprise any computer operating environment, such as hand-held devices, multiprocessor systems, microprocessor-based or programmable sender electronic devices, minicomputers, mainframe computers, and the like. The processor may also be practiced in distributed computing environments where tasks are performed by remote processing devices. Furthermore, the processor may comprise, for example, a mobile terminal, such as a smart phone, a cellular telephone, a cellular telephone utilizing Wireless Application Protocol (WAP) or unlicensed mobile access (UMA), personal digital assistant (PDA), intelligent pager, portable computer, a hand held computer, a conventional telephone, or a Wireless Fidelity (Wi-Fi) access point. The aforementioned systems and devices are examples and the processor may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Moreover, the semantic data consistent with embodiments of the disclosure may be analyzed without being stored. In this case, in-line data mining techniques may be used as data traffic passes through, for example, a caching server or network router. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the components illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip). Moreover, embodiments of the disclosure may be practiced in virtualized cloud computing platforms.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
receiving a plurality of network policies, each network policy comprising validity information;
receiving a first set of connectivity data associated with a subscriber device;
analyzing the first set of connectivity data to determine a first set of policies to enforce;
enforcing the first set of policies;
receiving a second set of connectivity data associated with the subscriber device;
analyzing the second set of connectivity data to determine a second set of policies to enforce; and
enforcing the second set of policies.

2. The method of claim 1, wherein receiving the plurality of network policies comprises receiving the plurality of network policies at a Policy and Charging Enforcement Function (PCEF) server.

3. The method of claim 2, wherein receiving the plurality of network policies comprises:
receiving the plurality of network policies from a Policy and Charging Rules Function (PCRF) server; and
storing the received plurality of network policies for subsequent enforcement.

4. The method of claim 3, wherein determining the second set of policies to enforce comprises determining the second set of policies to enforce without querying the PCRF server for the second set of policies.

5. The method of claim 3, wherein enforcing the second set of policies comprises:
retrieving the second set of policies from storage in the PCEF server; and
enforcing the second set of policies by the PCEF server.

6. The method of claim 1, wherein the validity information comprises conditions for activating a corresponding policy.

7. The method of claim 1, wherein receiving the first set of connectivity data comprises receiving an indication that the subscriber device is communicating at a first RAT.

8. The method of claim 7, wherein analyzing the first set of connectivity data to determine the first set of policies comprises determining which of the plurality of policies correspond to service provision under the first RAT.

9. The method of claim 7, wherein receiving the second set of connectivity data comprises receiving an indication that the subscriber device has switched from the first RAT to a second RAT.

10. The method of claim 9, wherein analyzing the second set of connectivity data to determine the second set of policies comprises determining which of the plurality of policies correspond to service provision under the second RAT.

11. The method of claim 7, wherein determining which of the plurality of policies correspond to the service provision under the first RAT comprises analyzing the validity information associated with at least one of the plurality of policies.

12. The method of claim 10, wherein determining which of the plurality of policies correspond to the service provision under the second RAT comprises analyzing the validity information associated with at least one of the plurality of policies.

13. The method of claim 1, wherein enforcing the second set of policies comprises deactivating ones of the first set of policies and activating previously inactivated policies.

14. An apparatus comprising:
a memory storage; and
a processing unit coupled to the memory storage, the processing unit being configured to:
receive a plurality of network policies, each policy comprising validity information defining at least one condition to activate a corresponding policy;
monitor a subscriber device through an analysis of connectivity data associated with the subscriber device;
determine, based on the connectivity data, a set of policies to enforce upon the subscriber device; and
enforce the set of policies.

15. The apparatus of claim 14, wherein the processing unit being configured to determine the first set of policies to enforce comprises the processing unit being configured to analyze the validity information associated with at least one of the plurality of network policies in view of the connectivity data.

16. The apparatus of claim 14, wherein the processing unit being configured to receive the plurality of network policies comprises the processing unit being configured to receive the network policies from a Policy and Charging Rules Function (PCRF) server.

17. The apparatus of claim 16, wherein the processing unit is further configured to store the plurality of network policies received from the PCRF server for subsequent retrieval.

18. The apparatus of claim 17, wherein the processing unit being configured to determine the set of policies comprises the processing unit being configured to determine the set of policies without subsequently interacting with the PCRF server.

19. A computer-readable medium having a set of instructions which, when executed by a computer, perform a method, the method executed by the set of instructions comprising:
receiving, at a Policy and Charging Enforcement Function (PCEF) server, a plurality of policies from a Policy and Charging Rules Function (PCRF) server, wherein each of the plurality of policies comprises at least one rule and at least one condition for activating the at least one rule;
receiving connectivity data associated with the subscriber session;
determining, at the PCEF, whether the connectivity data meets the at least one condition for activating the at least one rule; and
activating the at least one rule when the connectivity data meets the at least one condition.

20. The computer-readable medium of claim 19, further comprising:
receiving an indication that the connectivity data associated with the subscriber session has changed;
determining, at the PCEF, whether the changed connectivity data meets at least one new condition for activating at least one new rule; and
activating the at least one new rule when the changed connectivity data meets the at least one new condition.
